(19) United States
(12) Patent Application Publication
(10) Pub. No.: US 2009/0164654 A1
(43) Pub. Date: Jun. 25, 2009

(54) IPTV community based internet radio content proxy facility

(75) Inventor: Zlatko Krstulich, Ottawa (CA)

Correspondence Address: MARKS & CLERK, P.O. BOX 957, STATION B, OTTAWA, ON, K1P 5S7, CA

(73) Assignee: ALCATEL LUCENT, PARIS (FR)

(21) Appl. No.: 12/002,768

(22) Filed: Dec. 19, 2007

(51) Int. Cl. G06F 15/16

(52) U.S. Cl. 709/231

(57) ABSTRACT

A method and apparatus are provided for allowing one subscriber of an IPTV service to locate and pre-configure Internet-based IP radio channels of interest to others, and to invite the others to register for viewing the IP radio channels. The first subscriber browses the Internet for content of interest, invokes the necessary configuration steps required by that content site, and then invites others to register for the content. The IPTV network stores the location of the content and the required configurations for the invited users. When an invited user logs on to the IPTV network, the IPTV network presents the user with a list of pre-configured Internet streaming channels to which he or she has been invited by another subscriber. If the invited user accepts an invitation to a channel located by the other subscriber, then the channel is added to the list of channels accessible by the user, and can thereafter be accessed by that user without familiarity of use of or direct access to the Internet proper.

### FIELD OF THE INVENTION

The invention relates to Digital Switched TV (also known as IPTV), and more particularly to Internet streaming media channel selection using IPTV.

### BACKGROUND OF THE INVENTION

There are hundreds of radio stations currently accessible via the Internet, and the selection is growing rapidly. Real-time Internet streamed radio content offers the public a wider selection of programming content, access to local news from a home town while traveling, and connection to a culture, language, or place for immigrant and expatriate populations. With much of the world's population being ever more globally mobile for work, study, and leisure, access to “place shifted” worldwide radio programming will continue to grow in demand.

This demand will be particularly strong within major urban centers which attract a large population of expatriates and immigrants who retain a life-long affinity to stay connected with news and programming from their home community. Unfortunately access to internet radio programming requires equipment, services, and knowledge beyond what is required for simple consumer entertainment. Typically, a user employs a personal computer and subscribes to a high speed Internet access service. The user employs a web browser to go to a website that provides Internet access to a radio station of interest, and follows the proper access procedures. Sometimes new media player software must be downloaded.

This is a particular problem for older people who tend to be less familiar with Internet use. The appeal of listening to Internet streamed radio is therefore currently limited to technically savvy Internet users having computers and broadband Internet access.

One type of solution requires the use of proprietary home appliances, such as that described in U.S. Patent Application Publication 2006/0067304 entitled “Internet radio receiver with linear tuning interface”. Another example of this type of solution is the service provided by www.penguinradio.com, which requires that the user subscribe to a broadband high speed Internet access service and purchase an in-home “player” appliance. The Penguin Radio solution also requires a service provider to set up a dedicated back-end Internet programming guide server infrastructure.

Another solution is described in U.S. Patent Application Publication 2002/0012353 entitled “ISD controlled set-top box”. In this solution, an IPTV infrastructure is used for the distribution of streaming radio. This eliminates the need for the user to subscribe to a high speed Internet access service or to purchase a proprietary player, as a standard digital set-top box and television handle playing of the content. However, an Internet programming guide must still be built and maintained. A caching capability is also described, which may be a problem from a copyright perspective.

There are two technical problems which must be addressed in order to reach the wider market. First, mass access to Internet streamed radio should be provided via consumer devices such as televisions, rather than through computers and high speed Internet access service. Second, the requirement for an end-user to navigate websites and load compatible media streaming players should be facilitated, or even avoided. Preferably, these two problems should be addressed using a content selection and delivery mechanism which does not require the broadcast distributor to be forced in to content negotiations with the programming source. A system which addressed these three problems would allow Internet streamed radio to reach a wider audience.

### SUMMARY OF THE INVENTION

In accordance with one aspect of the invention, a method is provided for providing a subscriber to an IPTV service with access to Internet streaming content through an IPTV network which offers the IPTV service. A media channel configuration user (MCCU) selects a source of Internet streaming content while browsing the Internet through the IPTV network. The MCCU establishes configuration data which allows viewing of the Internet streaming content, and the configuration data is stored within the IPTV network. When the subscriber selects the source of Internet streaming content for viewing, the IPTV network configures viewing of the Internet streaming content using the configuration data established by the MCCU. The IPTV network establishes a media stream from the source of the Internet streaming content to the subscriber.

In accordance with another aspect of the invention, a system is provided for providing a subscriber to an IPTV service with access to Internet streaming content. The system includes means for a media channel configuration user (MCCU), different from the subscriber, to identify a source of Internet streaming content and to identify configuration data which allows viewing of the Internet streaming content. A database stores the identity of the source of Internet streaming content and stores the configuration data. The system includes means for displaying the Internet streaming content to the subscriber through the IPTV service using the configuration data.

Apparatus are provided for carrying out the methods of the invention. The methods of the invention may be stored as processing instructions on computer-readable media.

The methods and apparatus of the present invention allow a user familiar with internet use (who will be referred to herein as a Media Channel Configuring User, or MCCU) to browse the Internet and locate IP radio stations or other streaming content of interest to others, such as friends, family (especially elderly parents), or community members. The MCCU can then invite others to add the streaming media selection as a channel on their IPTV service through a simple invite/accept process accessed via their own televisions. From the point of view of IPTV users, who may be less technology savvy or less inclined to browse the Internet, and who may not have a computer or subscribe to an Internet Access Provider service, an invitation to register with a channel appears when the user turns on their television and where IPTV service providers typically provide a welcome page. The user need simply accept the invitation, and the IPTV network thereafter presents the selected media stream (such as a radio broadcast) as one of the offered channels for that particular subscriber using the normal channel selection functionality. This allows a user to be shielded from the “difficult” work of locating and configuring IP radio stations using a computer and browser, and instead delegate such work to a “super-user”. One particular advantage of the invention is that the IPTV network merely stores a pointer to and configuration details for each Internet media content stream of interest, but does not store or buffer the actual content itself. Any possible copyright issues are thereby mitigated.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of a network according to one embodiment of the invention;

FIG. 2 is a flowchart of a method by which the web proxy server of FIG. 1 enables an MCCU to select channels according to one embodiment of the invention;

FIG. 3 is a flowchart of a method by which the IPTV middleware server FIG. 1 enables an MCCU to invite users to access configured channels according to one embodiment of the invention;

FIG. 4 is a flowchart of a method by which the IPTV middleware server of FIG. 1 enables a user to accept invitations to configured channels according to one embodiment of the invention; and

FIG. 5 is a diagram of a network according to another embodiment of the invention.

It will be noted that in the attached figures, like features bear similar labels.

### DETAILED DESCRIPTION OF THE EMBODIMENTS

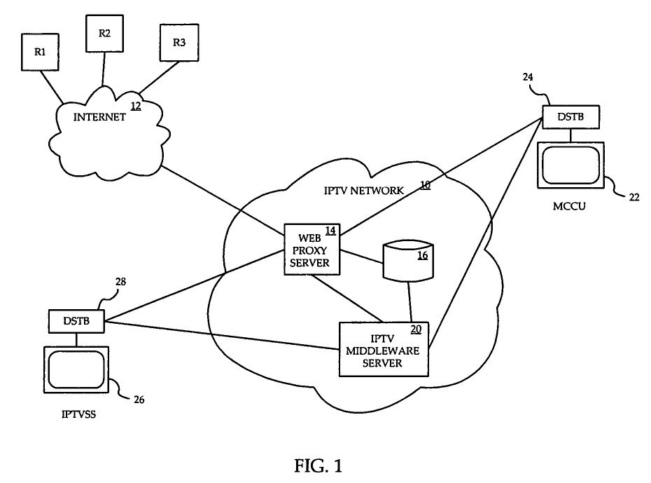

Referring to FIG. 1, an example network according to one embodiment of the invention is shown. An Internet Protocol Television (IPTV) network 10 is administered by an IPTV service provider. The IPTV network 10 connects to the Internet 12, through which the IPTV network can receive streamed content from Internet radio stations R1, R2, and R3. There may of course be any number of Internet radio stations providing streamed content into the Internet 12. The IPTV network 10 includes a proxy web server 14, database 16, and an IPTV middleware server 20. Subscribers to the IPTV service typically have a digital set-top box (DSTB) which adapt IPTV media to their local television, as well as an interface device (such as a remote control wand or a full QWERTY keyboard) with which to manipulate the IPTV service.

A first user accesses the IPTV network 10 through a television 22 and a DSTB 24. A second user access the IPTV network 10 through a different television 26 and a different DSTB 28. The first user will be responsible for configuring channel information for the second user and will be referred to herein as a media channel configuration user (MCCU). The second user will be a different subscriber to the IPTV service and will be referred to herein as in IPTV service subscriber (IPTVSS). In general, there will be a plurality of users, any of whom and any number of whom may act as an MCCU.

The database 16 contains, for each user, a Service Channels List and a User-Defined Channels List. The Service Channels List of a user identifies all channels registered to the user and that the user may access, given a service package to which the user has subscribed. The User-Defined Channel List of a user identifies a list of Internet configuration records. Each Internet configuration record includes information sufficient to identify, access, and play streamed Internet content from an Internet radio station, and may include an Internet radio station identifier, an identifying image or text, a URL for the source of the streamed content from the Internet radio station, a series of web browsing macros sufficient to configure the streamed content, media player configuration information for identifying the particular media player software required for playback of the streamed content, settings for playback of the streamed content, Internet site log-on passwords, and the identity of the MCCU who configured the channel. Each Internet configuration record also includes an access field which may be set to “active” or “pending”, as described below. The mapping of the Internet configuration records to a user's television “dial position” may be user configurable, such as is the common practice for establishing a “favorite channels” list.

The web proxy server 14 includes functionality which allows the MCCU to browse the Internet 12 while capturing browsing commands as a series of macros. The IPTV middleware server 20 includes functionality which allows the MCCU to create an Internet configuration record by associating an Internet radio station's identity, a URL, and other pertinent configuration information for the Internet radio station's site, and to store the Internet configuration record in the database 16. The IPTV middleware server 20 also includes functionality which allows the MCCU to invite an IPTVSS to one or more channels identified by such Internet configuration records. The IPTV middleware server 20 also includes functionality which allows an IPTVSS to accept such an invitation.

Broadly, in operation an MCCU browses the Internet 12 through the web proxy server 14. The MCCU identifies an Internet radio station and creates a record pertaining to that Internet radio station for storage in the database 16. The MCCU invites one or more users to the channel. When an invited user accesses the IPTV network 10, the invited user is presented with an invitation to the channel identified by the MCCU. If the user accepts the invitation, the channel is added to the list of channels which may be selected by the user.

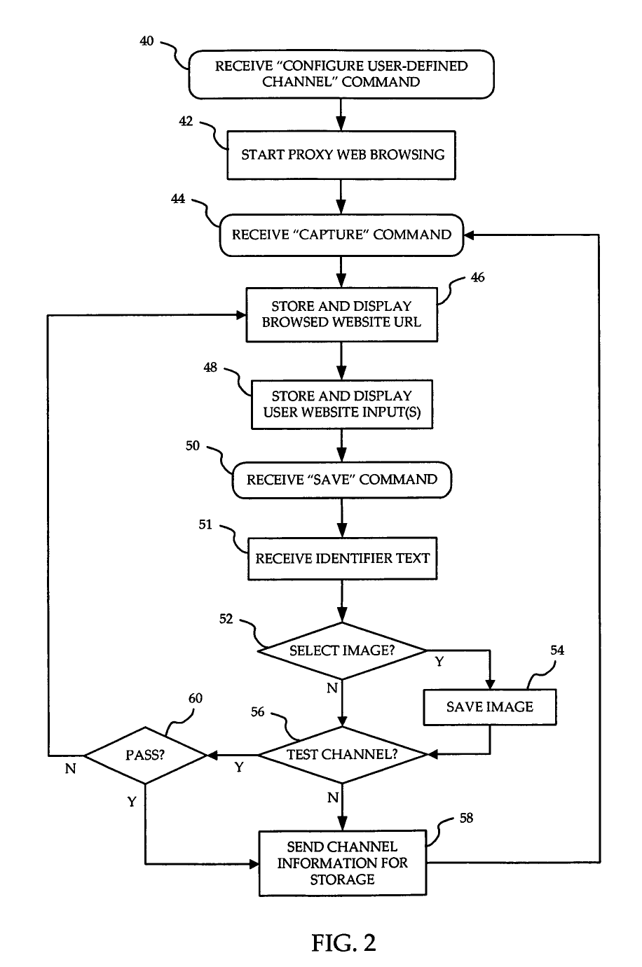

Referring to FIG. 2, a method by which the web proxy server 14 enables the MCCU to select channels according to one embodiment of the invention is shown. The method is executed while the MCCU is logged into the IPTV network 10 using their television. At step 40 the web proxy server 14 receives a “Configure User-Defined Channels” command from the MCCU. At step 42 the web proxy server 14 provides web browsing access to the MCCU. Although the MCCU's web browsing experience is very similar to a normal web browsing session not involving the IPTV, all MCCU commands to the Internet 12 and data from the Internet 12 pass through the web proxy server 14. As a result, the web proxy server 14 is able to capture user commands and website responses. In addition, the web server proxy 14 is able to ‘pop up’ windows on the MCCU's browser screen in order to assist in prompting the MCCU through the process of setting up a user-defined channel.

Once the MCCU is provided with web browsing access by the web proxy server 14, the MCCU browses the web searching for an Internet radio station of interest. Once the MCCU locates such an Internet radio station, the MCCU selects a “Capture” command and then enters inputs at the website of the Internet radio station so as to configure access to the Internet radio station. At step 44 the web proxy server 14 receives a “Capture” command. At step 46 the web proxy server 14 stores and displays the URL of the website being browsed by the MCCU when the “Capture” command was entered. At step 48 the web proxy server 14 stores and displays (for example, in a pop-up window or sidebar) any user website inputs that were entered by the MCCU at the website being browsed by the MCCU after the “Capture” command was entered. If the MCCU is satisfied with the displayed URL and any inputs, the MCCU may enter a “Save Channel” command, and at step 50 the web proxy server 14 receives a “Save Channel” command.

At step 51 the web proxy server 14 prompts for and receives user-defined identifier text from the MCCU. The identifier text may be a short description of the corresponding Internet radio station which would allow another user, such as a friend or family member of the MCCU, to easily identify the Internet radio station irrespective of the official Internet radio station identifier used by the radio station.

At step 52 the web proxy server 14 prompts for and receives a decision as to whether the MCCU wishes to select an image to associate with the Internet radio station. If the MCCU indicates that an image is to be associated with the Internet radio station, then at step 54 the web proxy browser 14 saves an image selected by the MCCU. The image may be selected from any source, such as an image on the website of the Internet radio station itself, thereby assisting another user to readily identify the Internet radio station when presented with the image.

At step 56 the web proxy server 14 prompts for and receives a decision as to whether the MCCU wishes to test the channel selected in earlier steps. If the MCCU does not wish to test the channel, then at step 58 the web server proxy 14 sends the channel information (including the URL of the Internet radio station, any inputs entered by the MCCU in order to configure listening to the Internet radio station, any identifier text selected by the MCCU, and any image selected by the MCCU) to the IPTV middleware server 20. The IPTV middleware server 20 creates an Internet configuration record for the channel and stores the new Internet configuration record in the User-Defined Channels List of the MCCU within the database 16. The IPTV middleware server 20 sets the access field of the new Internet configuration record to “active”. Thereafter, the IPTV network provides the channel associated with the new Internet configuration record as one of the channels available for viewing by the MCCU during an IPTV session. Once the web proxy server 14 has sent the channel information to the IPTV middleware server 20, the web proxy server 14 allows the MCCU to resume browsing the Internet 12 and entering input, and awaits receipt of a new “Capture” command at step 44.

If the MCCU elects at step 56 to test the new channel, then the web proxy server 14 opens a “pop-up” window and attempts to play the streamed media content using macros and the URL within the newly created Internet configuration record, so as to mimic a working IPTV user's experience when tuning into that channel. If the MCCU indicates at step 60 that the test has succeeded, then the web proxy server 14 sends the channel information to the IPTV middleware server 20 at step 58, as described above. If the MCCU indicates at step 60 that the test has failed, then the web proxy server 14 allows the MCCU to resume browsing the Internet 12 and entering input, and awaits receipt of a new “Capture” command at step 44. One situation in which the test would fail would be if the media stream type of the channel requires a media player which is not supported by the IPTV network 10.

The MCCU can log out or exit the browsing function at any time.

The web browsing functionality offered by the IPTV network to the MCCU may be restricted in terms of effective download speeds or length of time permitted for browsing. This prevents the IPTV network's facilities from being used for purposes other than those intended.

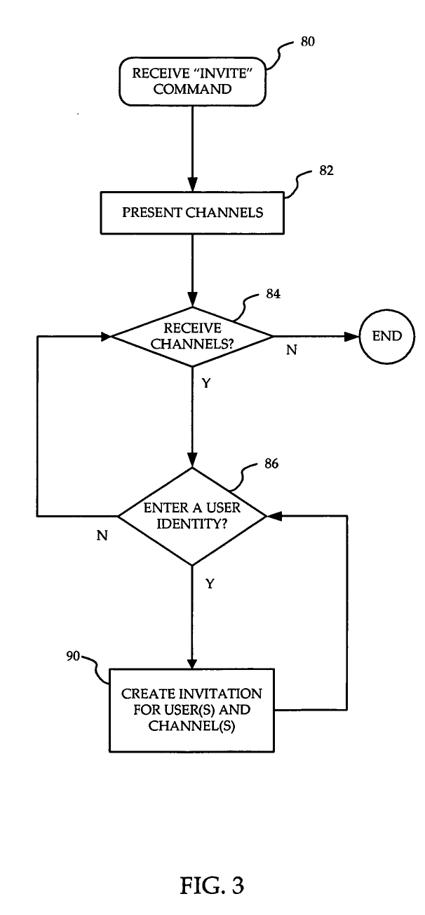

Referring to FIG. 3, a method by which the IPTV middleware server 20 enables the MCCU to invite users to selected channels according to one embodiment of the invention is shown. The method is executed while the MCCU is logged into the IPTV network 10. At step 80 the IPTV middleware server 20 receives an “Invite Users” command from the MCCU. At step 82 the IPTV middleware server 20 presents a list of user-defined channels which have been registered for the MCCU, as indicated by the User-Defined Channels List for the MCCU within the database 16. At step 84 the IPTV middleware server 20 receives a selection of channels from the MCCU. If the selection received at step 84 is empty, such as would be the case if the MCCU decided to exit the routine, then the method ends.

If the selection received at step 84 includes at least one channel, then at step 86 the MCCU is prompted to enter a user identity. The MCCU may enter the user identity in any form, such as by first and last name, subscriber number, or shared secret identity as obtained from the user. If the MCCU does not enter a user identity, for example by choosing a “no more users” control, then the web proxy server 14 awaits reception of a new set of channels at step 84. If the MCCU does enter a user identity, then at step 90 the IPTV middleware server 20 adds channels received at step 84 to the User-Defined Channels List of the user, identified by the user identity, within the database 16. When adding such channels to the User-Defined Channels List of the user identified at step 86, the IPTV middleware server 20 sets the value of the access field to “pending”. This indicates to the IPTV network 10 that the channel is not yet to be presented for selection for viewing by the user.

The IPTV middleware server 20 does not add any channels which are already in the User-Defined Channels List of the user. This means that a potential invitee will not be invited to join channels for which he or she is already configured, and will not be invited to a channel more than once simultaneously. Once any new channels (i.e. those to which the potential invitee has not already been invited and for which the potential invitee is not already configured) are added to the User-Defined Channels List of the invitee user, the IPTV middleware server 20 invites the MCCU to enter another user identity at step 86.

In one embodiment the MCCU may be alerted to the fact that the potential invitee user is already invited to or registered for some of the channels, but this may intrude on the privacy of the potential invitee. In the preferred embodiment the MCCU is given no such alert, and the IPTV middleware server 20 simply discards the invitation silently.

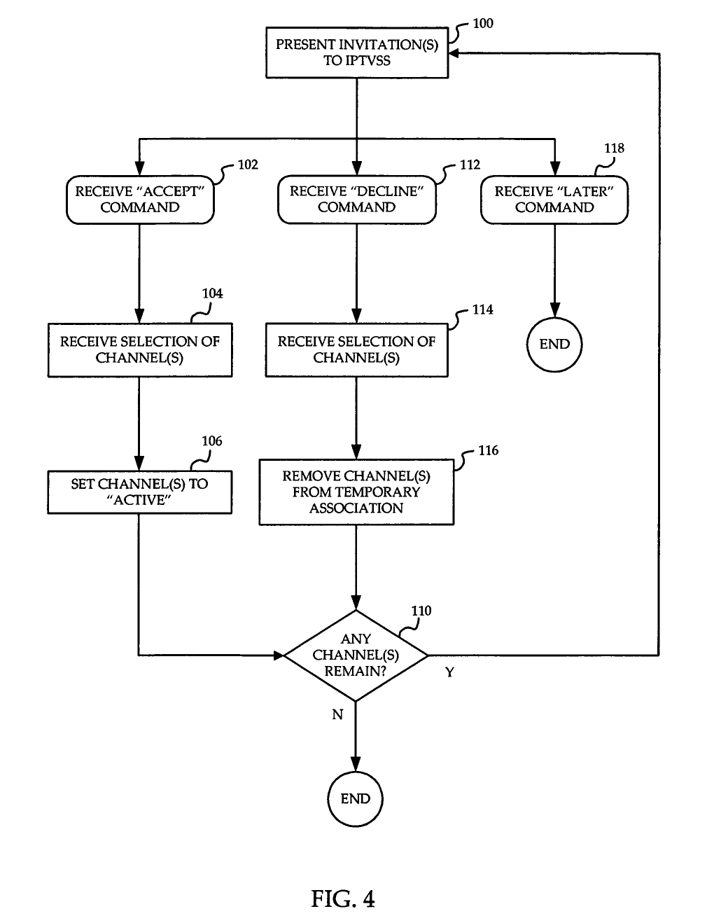

Referring to FIG. 4, a method by which the IPTV middleware server 20 enables an IPTVSS to accept or reject invitations to channels according to one embodiment of the invention is shown. The method is executed when the IPTVSS logs into the IPTV network 10 and there are channels listed as “pending” in the User-Defined Channels List of the user. The IPTV middleware server 20 presents to the IPTVSS a list of channels listed in the User-Defined Channels List of the IPTVSS which have an access field value of “pending”, along with three command options: an “Accept” command, a “Decline” command, and a “Later” command. At this point the IPTVSS may select one or more of the channels which were presented at step 100.

If the IPTV middleware server 20 receives an “Accept” command (at step 102), then the IPTV middleware server 20 receives the IPTVSS selection of channels at step 104. At step 106 the IPTV middleware server 20 sets the selected channels as available for selection for viewing by the IPTVSS by setting the access field of the Internet configuration record for the channel to “active” within the User-Defined Channels List of the IPTVSS. Thereafter, the IPTVSS will be presented with the channels for which the IPTVSS accepted the invitation when selecting a channel to view or access during normal interaction with the IPTV network 10.

At step 110 the IPTV middleware server 20 determines whether there are any more channels with a “pending” status in the User-Defined Channels List of the IPTVSS. If there are no more channels in the Invited Channels List, then all channels to which the IPTVSS has been invited have been dealt with in some way, and the IPTV middleware server 20 ends inviting the IPTVSS to channels. If any channels in the User-Defined Channels List still have a “pending” status, then the IPTV middleware server 20 presents once again to the IPTVSS a list of such channels, along with the three command options. This list of channels may be shorter than the list presented when the user logged in to the IPTV network 10, since the IPTVSS may have already accepted invitations to some of the channels.

If the IPTV middleware server 20 receives a “Decline” command from the IPTVSS at step 112, then the IPTV middleware server 20 receives the selection of channels at step 114. At step 116 the IPTV middleware server 20 removes the Internet configuration records of the selected channels from the User-Defined Channels List of the IPTVSS. At step 110 IPTV middleware server 20 determines whether there are any more channels having a “pending” status in the User-Defined Channels List of the IPTVSS. If there are no more such channels, then all channels to which the IPTVSS has been invited have been dealt with in some way, and the IPTV middleware server 20 ends inviting the IPTVSS to channels. If any such channels still remain in the User-Defined Channels List then the IPTV middleware server 20 presents once again to the IPTVSS a list of channels in the User-Defined Channels List of the IPTVSS which have an access field value of “pending”, along with the three command options.

If the IPTV middleware server 20 receives a “Later” command from the IPTVSS at step 118, then the IPTV middleware server 20 ends inviting the IPTVSS to channels, without further modifying the User-Defined Channels List of the IPTVSS. In this way, the IPTVSS may leave acceptance of invitations for some channels for future consideration. The next time the IPTVSS logs in to the IPTV network 10, he or she will be presented with invitations for the channels for which acceptance was deferred, and of course any additional channels to which the IPTVSS has been invited in the meantime.

During use of the IPTV service by the IPTVSS subsequent to acceptance of an invitation, the IPTVSS may choose to tune in to one the previously configured channels in the User-Defined Channels List. If such a channel is in fact a pointer to Internet streaming content then the IPTVSS DSTB will message the IPTV middleware server 20 to indicate which user-defined channel is to be viewed. Each time the IPTVSS selects such a channel, the IPTV middleware server 20 retrieves the corresponding Internet configuration record from the database 16 and retrieves the corresponding configuration parameters and macros for that channel. The IPTV middleware server 20 then orchestrates a process via the web proxy server 14 to establish a particular media stream from the Internet and to set-up appropriate playback configuration parameters within the IPTV system to ensure compatibility with the type of media stream expected from the Internet. The IPTV middleware server 20 directs the web proxy server 14 to launch a particular media stream from the Internet. The web proxy server 14 invokes the stored macros using its Internet browsing capability and accesses the target website via the Internet 12. The web proxy server 14 is in fact mimicking the configuration commands that the MCCU had issued when configuring the Internet streaming media channel described above with respect to the “Capture” and “Save” commands of FIG. 2.

The web proxy server 14 and the link to the Internet 12 have the capability to support numerous simultaneous proxy browsing sessions and individual Internet media streams. The IPTV middleware server 20 tags and switches the media streams through the IPTV network so that the appropriate streams reach the target IPTVSSs. In one embodiment, the IPTV network employs a multi-casting facility to replicate IPTV media streams to multiple IPTVSSs. In situations where popular Internet streaming sites have been selected for viewing by many IPTVSSs, multi-casting can reduce the total bandwidth requirements in parts of the IPTV network, such as the link to the Internet 12.

In one embodiment, when an IPTVSS deselects (or tunes out) of a user-defined channel, the Internet session is terminated and the content is no longer streamed into the IPTV network. While this minimizes the amount of traffic flowing from the Internet to the IPTV network, it could result in delays of several seconds as the IPTVSS jumps back and forth between user-defined channels as the IPTV network must re-establish connections each time the IPTVSS selects one of the user-defined channels pointing to streaming Internet media content. In an alternative embodiment, the IPTV network maintains all such streams accessed by the IPTVSS during an active viewing session, either maintaining the streams for a pre-defined time (e.g. an hour) or for the duration of the active viewing session. This allows the IPTVSS to switch back and forth between such channels without experiencing significant latency. As yet another alternative, the IPTV network may immediately configure all user-defined channels associated with an IPTVSS when the IPTVSS logs on or starts using his or her IPTV service, even before any such channels have been selected by the IPTVSS.

The invention is preferably implemented as software on the web proxy server 14 and the IPTV middleware server 20. The invention may alternatively be implemented as hardware on some or all of the devices within FIG. 1, or as a combination of software and hardware. If in the form of software, the logical instructions may be stored on a computer-readable medium.

In one embodiment, the IPTV middleware server 20 monitors a media stream selected for viewing by a user from the User-Defined Channels List of the user for consistency with characteristics of a valid audio or video flow. If the IPTV middleware server 20 determines that the data stream of the selected channel is not consistent with a valid audio or video flow, or in fact is absent altogether, the IPTV middleware server 20 determines from the Internet configuration record of the channel within the User-Defined Channels List which MCCU configured the channel and invited the user. The IPTV middleware server 20 then sends an alert to the MCCU indicating that there may be a problem with the configured channel and that the site which was the source of the content may need to be revisited.

The invention has been described such that Internet configuration records are created by the MCCU one at a time (as described with reference to FIG. 2), and then other users are invited by the MCCU one at a time as a separate operation (as described with reference to FIG. 3). Although such a method provides great flexibility, the creation of Internet configuration records for channels and the invitation of users may be intermixed in any of a number of ways. As one example, the MCCU may create an Internet configuration record (i.e. select a new channel while browsing the Internet 12) and then immediately invite users before creating another Internet configuration record for another channel. As another example, the MCCU may create a list of multiple other users which is stored in the IPTV network 10. The MCCU may then invite the entire group of multiple other users to register with a newly selected channel. The MCCU may even create several such lists of multiple other users, some of which may overlap. This allows the MCCU to, for example, collectively invite some friends to some channels and collectively invite some family members to other channels. As yet another example, the MCCU may create a group of Internet configuration records, such as for a group of channels from a particular country. The MCCU may then invite users, either individually or as a group, to register with the entire group of newly created channel records. In general the MCCU may select new channels and invite new users to the new channels in any manner.

The invention has been described in which the MCCU enters a single user identity when inviting users to a channel. Alternatively, the MCCU may define a list of users ahead of time. Such a list is stored in the database 16, the entries of such a list comprising a user identity easily recognized by the MCCU (such as a nickname) and a user identification used by the web proxy server 14 to identify the corresponding customer (such as by account number). When the MCCU wishes to invite a user to a channel or channels, the MCCU simply selects one of the users in the stored list. Of course the IPTV middleware server 20 would include functionality for modifying the list of users by allowing the MCCU to add members to the list or remove members from the list.

The invention has been described such that a user is simply presented with a list of channels to which he or she has been invited (described with reference to FIG. 4). Alternatively, the list of channels may also indicate an identity of the MCCU that invited the user to each channel in the list, since more than one user may have invited the user to channels. This would allow the user to accept invitations only from other users that he or she knew and trusted. Such an embodiment requires an extra field in the Internet configuration records within the User-Defined Channels List of the user, the extra field storing the identity of the MCCU which invited the user to the channel defined by the Internet configuration record. If more than one MCCU invites a user to a particular channel, then the first invitation stored in the User-Defined Channels List can be overwritten by the subsequent invitation, the subsequent invitation can be ignored, or both invitations can be stored in the User-Defined Channels List and presented to the user upon login but distinguished by the identity of the inviting MCCU.

The invention has been described as allowing any user to invite other users to channels. Alternatively, only invitations from trusted MCCUs may be allowed to be added to the User-Defined Channels List of the user. In such an embodiment, a list of trusted MCCUs is stored at the IPTV 10 for the user. Channels would only be added to the user's User-Defined Channels List (described above with respect to step 90 of FIG. 3) if the inviting MCCU is listed in the list of trusted MCCUs for the user. The inviting MCCU may be listed in the User-Defined Channels List and presented to the user upon login, but this is less important since the user would know that only trusted MCCUs could invite the user to register with channels.

The invention has been described as an MCCU browsing for Internet radio channels and then inviting users to register with the Internet radio channels. Alternatively, other sources of Internet streaming content may be selected by an MCCU for invitation of others. For example, as IP television stations become more abundant, an MCCU could locate IP television stations of interest to friends and family, and invite others to register for viewing the IP television stations. The Internet streaming content may in general be any combination of audio and video content.

The invention has been described as storing an Internet configuration record for a channel to which a user has been invited in a User-Defined Channels List of the user. Information representative of an invitation may be stored in other ways, such as storing Internet configuration records in separate tables, and then for each invitation storing a pointer to the appropriate Internet configuration record along optionally with an identification of the MCCU who invited the user to the channel. As another option, Internet configuration records for channels to which a user has been invited may be stored in an Invited Channels List, and then copied to the User-Defined Channels List upon acceptance of an invitation. In general, when the MCCU indicates that an IPTVSS is to be sent an invitation to selected Internet streamed content, the IPTV network stores information representative of an invitation so that the invited user can be sent an appropriate invitation.

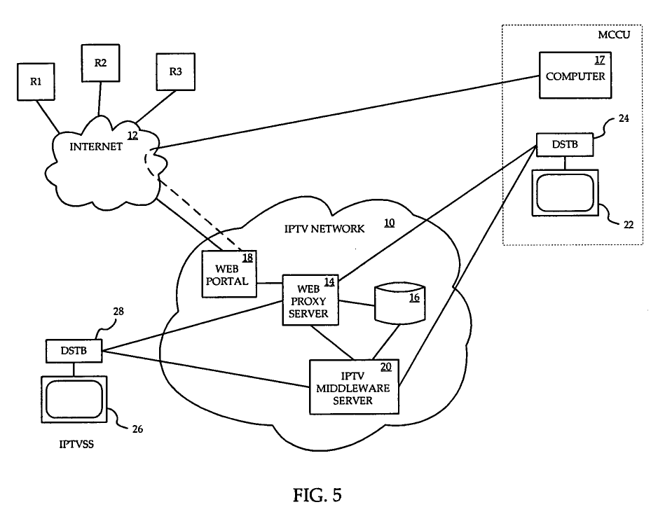

The invention has been described as an MCCU accessing the web proxy server and browsing the Internet through a digital set-top box. Alternatively, other devices may be used by the MCCU for accessing the web proxy server, such as a personal computer. Referring to FIG. 5, an example network according to this embodiment of the invention is shown. The network is similar to that described above with reference to FIG. 1, except that the IPTV network 10 also includes a secure web portal 18. The MCCU may access the IPTV network 10 using a computer 17 through the Internet 12 and the secure web portal 18 (where the MCCU's credentials for access may be established), and thereafter browse for and select Internet streamed content and invite other users to selected Internet streamed content as described above. Such an embodiment also allows the MCCU to not actually be a subscriber of the IPTV service. Rather, the MCCU may be a trusted third party who is provided with credentials by an IPTVSS, which allows the MCCU to log-on to the secure web portal 18 and then pre-configure a series of radio channels (or other streamed media content) for the IPTVSS with which the third party MCCU has an affiliation.

The embodiments presented are exemplary only and persons skilled in the art would appreciate that variations to the embodiments described above may be made without departing from the spirit of the invention. For example, the functionality described above as residing on each of the web proxy server 14 and the IPTV middleware server 20 may be distributed in any way over the two devices, or in fact may be combined onto a single server. Certain features of the invention may be optional, such as prompting for and saving an image for association with an Internet radio station, without departing from the main spirit of the invention.

We claim:

1. A method of providing a subscriber to an Internet Protocol Television (IPTV) service with access to Internet streaming content through an Internet Protocol Television (IPTV) network which offers the IPTV service, the method comprising:
selecting, by a media channel configuration user (MCCU) browsing the Internet through the IPTV network, a source of Internet streaming content;
establishing, by the MCCU, configuration data which allows viewing of the Internet streaming content and storing the configuration data within the IPTV network;
upon selection by the subscriber of the source of Internet streaming content for viewing, the IPTV network configuring viewing of the Internet streaming content using the configuration data established by the MCCU; and
establishing a media stream from the source of the Internet streaming content to the subscriber through the IPTV network.

2. The method of claim 1 wherein establishing a media stream from the source of the Internet streaming content comprises establishing a multicast media stream within the IPTV network to more than one subscriber.

3. The method of claim 1 further comprising maintaining the media stream from the source of the Internet streaming content to the subscriber when the subscriber selects an alternate channel for viewing.

4. The method of claim 1 wherein the selection by the subscriber of the source of Internet streaming data is made using user-defined channels.

5. The method of claim 1 wherein the MCCU is a subscriber to the IPTV service.

6. The method of claim 1 wherein the MCCU is not a subscriber to the IPTV service and is a trusted third party who is provided with credentials by the subscriber.

7. The method of claim 6 wherein selecting, by an MCCU browsing the Internet through the IPTV network, a source of Internet streaming content comprises the MCCU accessing the IPTV network through a secure web portal.

8. The method of claim 1 wherein establishing configuration data comprises storing at the IPTV configuration macros entered by the MCCU.

9. The method of claim 1 further comprising:
upon initiation by the MCCU, sending an invitation from the IPTV network to the subscriber, the invitation identifying the source of Internet streaming content; and
upon acceptance of the invitation by the subscriber, configuring subscriber data at the IPTV network such that the subscriber can select the source of Internet streaming content.

10. The method of claim 9 wherein the subscriber data comprises associating a user-defined channel with the source of Internet streaming content.

11. The method of claim 9 wherein sending an invitation to the subscriber comprises identifying the MCCU to the subscriber.

12. The method of claim 9 wherein sending an invitation to the subscriber comprises creating an Internet configuration record associated with the subscriber, the Internet configuration record containing the configuration data established by the MCCU.

13. The method of claim 12 wherein creating the Internet configuration record comprises setting a field within the Internet configuration record to a value indicating that viewing of the Internet streaming content is pending, and wherein configuring subscriber data upon acceptance of the invitation by the subscriber comprises setting the field to a value indicating that viewing of the Internet streaming content is active.

14. A system for providing a subscriber to an Internet Protocol Television (IPTV) service with access to Internet streaming content, comprising:
means for a media channel configuration user (MCCU) different from the subscriber to identify a source of Internet streaming content and to identify configuration data which allows viewing of the Internet streaming content;
a database for storing the identity of the source of Internet streaming content and the configuration data;
means for displaying the Internet streaming content to the subscriber through the IPTV service using the configuration data.

15. The system of claim 14 wherein the means for displaying the Internet streaming content to the subscriber comprise means for displaying the Internet streaming content when the subscriber selects a user-defined channel of the IPTV service.

16. The system of claim 14 wherein the database stores configuration macros entered by the MCCU as part of the configuration data.

17. The system of claim 14 wherein the means for displaying the Internet streaming content to the subscriber comprise means for establishing a media stream from the source of the Internet streaming content to a digital set-top box of the subscriber.

18. The system of claim 17 wherein the means for displaying the Internet streaming content comprise means for displaying the Internet streaming content when the subscriber selects a user-defined channel of the IPTV service, and further comprising means for maintaining the media stream in the event that the subscriber selects a different user-defined channel.

19. The system of claim 17 further comprising:
means for establishing associations between each of a plurality of user-defined channels and a respective source of Internet streaming content; and
means for establishing a media stream for each user-defined channel from the respective source of Internet streaming content and the digital set-top box of the subscriber.

20. The system of claim 14 wherein the means for displaying the Internet streaming content to the subscriber comprise means for establishing a multi-cast media stream from the source of the Internet streaming content to a plurality of subscribers, the subscriber being one of the plurality of subscribers.
